(19) United States
(12) Patent Application Publication
(10) Pub. No.: US 2017/0195364 A1
(43) Pub. Date: Jul. 6, 2017

(54) CYBER SECURITY SYSTEM AND METHOD

(71) Applicant: PERCEPTION POINT LTD., Tel Aviv (IL)

(72) Inventors: Shlomi LEVIN, Tel Aviv (IL); Yevgeny PATS, Tel Aviv (IL); Michael AMINOV, Modi'in (IL)

(21) Appl. No.: 14/988,781

(22) Filed: Jan. 6, 2016

(51) Int. Cl. H04L 29/06

(52) U.S. Cl. CPC H04L 63/1491

(57) ABSTRACT

A system and method for cyber security, the system including a digital minefield layer implemented in a computing environment, including multiple decoy resources in various layers of an operating system of the computing environment, and a detection module to detect interaction with at least one of the decoy resources. The method includes deploying, by a digital minefield layer implemented in a computing environment, multiple decoy resources in various layers of an operating system of the computing environment, and monitoring the decoy resources by a detection module to detect interaction with at least one of the decoy resources.

### BACKGROUND OF THE INVENTION

The majority of companies around the world have been breached by at least one cyber-attack over the previous three years. Some reports indicate that this number is greater than 90% of companies. Existing cyber security tools may be ineffective against new methods of security attacks and Advanced Persistent Threats (APT). Some attackers know how to bypass known existing tools. Security breaches that the existing tools fail to block may cause financial losses and leaks of intellectual property.

In most organization networks, the endpoint user devices/machines may be the most vulnerable devices. Endpoint machines may be exposed, for example, to zero-day attacks, spear phishing campaigns, malware, and more.

Various kinds of tools may use proactive deception including, for example, visual deception attacks and information warfare. Typically, current solutions use agents that collect data and try to classify malicious behavior by signatures, heuristics or mathematical models. Other solutions use deception techniques at the network level. However, current solutions do not provide sufficient level of security and lack the ability to detect APTs, zero-day attacks, and other advanced forms of cyber-attacks in real time.

### SUMMARY OF THE INVENTION

Some embodiments of the present invention may provide a system and method for cyber security, wherein the system may include: a digital minefield layer implemented in a computing environment, including multiple decoy resources in various layers of an operating system of the computing environment; and a detection module to detect interaction with at least one of the decoy resources. The decoy resources may be configured to lure an attacker to interact with them, wherein such interaction indicates that an attack is occurring, and wherein the detection module may detect the interaction and stop the attack in real time. The decoy resources may be imitations of potentially-targeted resources by an attacker, and may be monitored by the detection module. In some embodiments of the present invention, the decoy resources may be implemented in multiple layers of the operating system level and/or the RAM process level and/or in other resources corresponding to steps of a cyber-attack.

The digital minefield layer according to some embodiments of the present invention may further be implemented in endpoint machines originating from the computing environment that are located outside the computing environment in a given moment.

In some embodiments of the present invention, at least one of the decoy resources may be produced to imitate one of a list including: a point of sale (POS) software, a browser process, a process running by a domain admin, or another potentially targeted process.

In some embodiments of the present invention, the digital minefield layer deploys the decoy resources according to a policy or a smart algorithm.

The detection module according to some embodiments of the present invention may include a list of monitored decoy resources, wherein once a decoy resource is deployed it may be added to the list.

In some embodiments of the present invention, the detection module may include a callback function in a kernel of an operating system in the computing environment, which may be called when a handle to a resource is being opened. The callback function may check whether the resource accessed by the opened handle is one of the monitored resources, and if the accessed resource is a monitored resource, the callback function informs the detection module. Otherwise, access to the resource is granted.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A and 1B are schematic macro-level and micro level illustrations, respectively, of a computing environment and of a system for cyber security that may be implemented in the computing environment according to some embodiments of the present invention;

FIG. 2 is a schematic illustration of a digital minefield operation according to some embodiments of the present invention;

FIG. 3 is a schematic illustration of the operation of a network mine according to some exemplary embodiments of the present invention.

FIG. 4 is a schematic illustration of exemplary seven potential phases of a cyber-attack chain, which may be blocked by minefield layer that may be implemented in corresponding processes and layers of the OS, according to some embodiments of the present invention; and

FIG. 5 is a schematic flowchart illustration of a method for cyber security according to some embodiments of the present invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Some embodiments of the present invention may provide a system and method for cyber security that may enable proactive protection, for example of an organization network, for example by using enhanced deception techniques. The system and method according to embodiments of the present invention may provide endpoint machine protection that may ensure that the organization's resources are secured whether the machine is onsite or offsite, online or offline.

Proactive deception according to some embodiments of the present invention may detect APTs, zero-day attacks, and other advanced forms of cyber-attacks in real time. The Digital minefield according to some embodiments of the present invention may include implementation deceptive artifacts in different layers of the OS, thereby helping to minimize the time between initial breach, detection, and subsequent remediation.

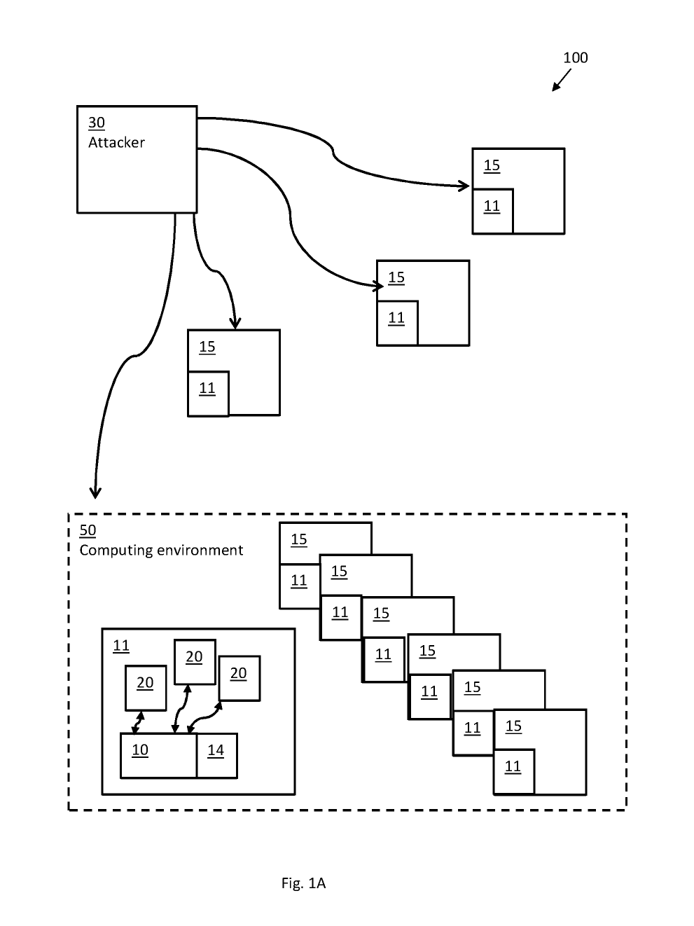

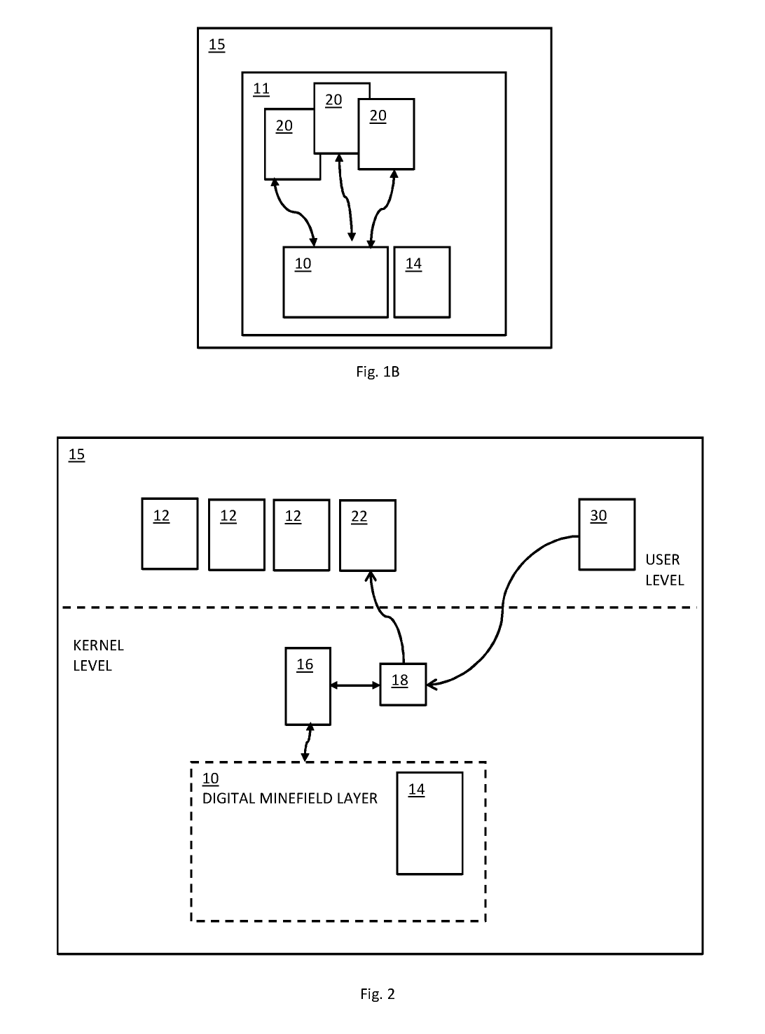

Reference is now made to FIGS. 1A and 1B, which are schematic and micro level illustrations, respectively, of a computing environment 50 and of a system 100 for cyber security that may be implemented in environment 50 according to some embodiments of the present invention. Computing environment 50 may be a computing environment of an organization, and may include multiple endpoint machines 15, for example mutually connected by a network. Environment 50 may also include endpoint machines 15 which may be originated from environment 50, and/or may be located in a given moment outside of environment 50. System 100 may include a digital minefield layer 10 that may be implemented in the operating system (OS) level 11, and/or in processes, objects and/or files of endpoint machines 15 in environment 50. Endpoint machines 15 may include computers, servers, appliances, mobile devices and/or any other suitable end-user devices. In some embodiments of the present invention, some of endpoint machines 15, for example machines 15 outside environment 50, may not have network connection with endpoint machines 15 in a given moment.

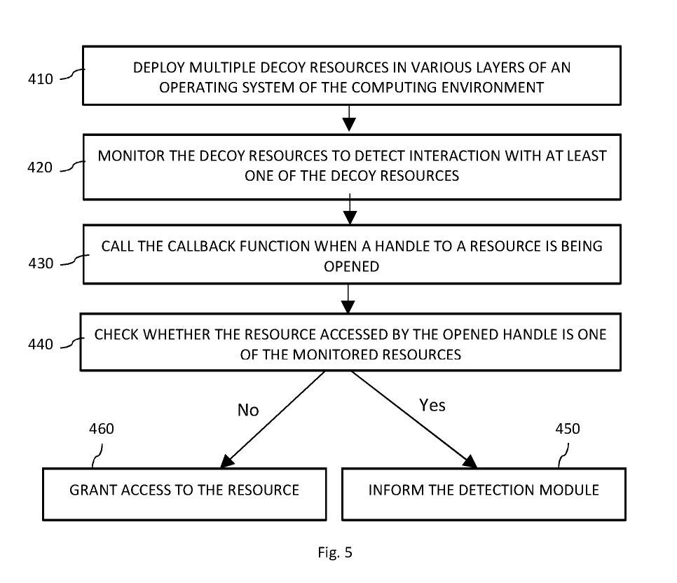

Once digital minefield layer 10 is implemented, each endpoint machine 15 in the organization may become a hazardous environment for a potential attacker 30. As an attack may include multiple stages of interaction with the operating system for the purpose of, for example, elevation of privileges, lateral movement, data exfiltration and/or other stages, digital minefield layer 10 may include mines 20 in different layers of OS 11 and in various process layers in endpoint machines 15 (as described in more detail with reference to FIG. 4), which may be potential targets of a cyber attacker 30. Mines 20 are configured to protect against different threat types and phases in the attack chain. Digital minefield layer 10 may further include a detection module 14 to detect interaction with at least one of mines 20.

Cyber attacker 30 may be a malicious person or a robot, for example that tries to obtain information and/or to sabotage operations in environment 50.

Digital minefield layer 10 may be integrated into endpoint machines 15 with substantially no noticeable impact on fluent operation by the user. Digital minefield layer 10 may include fully-automated process, for example, with no required maintenance and/or updates.

Reference is now made to FIG. 2, which is a schematic illustration of the operation of a digital minefield 10 implemented in a machine 15 according to some embodiments of the present invention. Digital minefield 10 may include multiple mines 20, which may include decoy deceptive resources 22, such as decoy files, processes and objects, that will lure the attacker to interact with them. Since no one is supposed to interact with decoy resources 22, such interaction indicates that an attack is occurring, and the attack may be stopped in real time. Additionally, minefield layer 10 may include a detection and termination module 14.

In some embodiments of the present invention, digital minefield layer 10 may be implemented in at least one of several layers and processes of the OS that correspond to potential phases of a cyber-attack chain, which are described in detail herein with reference to FIG. 4. Implementation of minefield layer 10 in several layers may enable layer 10 to block attacks in various phases and even on the most vulnerable systems.

Decoy resources 22 may run as any other OS process on machine 15. However, decoy resources 22 may be mere imitations of normal processes and therefore, for example, may not perform the actions of the normal imitated processes. Additionally, decoy resources 22 may be monitored by detection and termination module 14 of minefield layer 10. Therefore, once an attacker 30 tries to perform an action on a process in machine 15, he will be lured to act on a decoy resource 22 and will be detected.

In some exemplary embodiments of the present invention, decoy resources 22 may be produced to imitate a potentially targeted process 12 by an attacker, such as a point of sale (POS) software. An attacker may try to interfere with a running process 12 in the user level, for example a POS software, in order to obtain personal information, such as, for example, payment means details. Decoy resource 22 that resembles process 12 may be produced, for example, periodically, and may be monitored by detection and termination module 14. Attacker 30 may automatically search for process 12, find the deceptive decoy resource 22 and interact with it, for example try to perform a reading operation on it. The interaction of attacker 30 with the monitored decoy resource 22 may be detected by detection and termination module 14, and the attack may be stopped by detection and termination module 14 in real time.

Similarly, attacker 30 may be a banking Trojan trying to inject himself into a browser process. Accordingly, deceptive resource 22 may be disguised as a browser. Once attacker 30 tries to inject code into deceptive resource 22, detection and termination module 14 may detect the interaction and terminate the attack in real time.

In some exemplary embodiments of the present invention, decoy resources 22 may be produced to imitate a process that runs by the domain admin, for example in order to detect and terminate a lateral movement attack. For example, in windows domain based organizations the attacker may look for a process running with higher privileges than he currently has. Once attacker 30 spots a process running with domain admin authorizations, he will try to interact with that process in order to obtain the admin authorizations. Decoy processes 22 may be produced, for example, by adding an artificial domain admin to the server or, for example, by changing the name string in the process to imitate an admin Once attacker 30 interacts with the monitored decoy resource 22, the interaction may be detected by detection and termination module 14, and the attack may be stopped by detection and termination module 14 in real time.

Similarly, to the examples herein, any process may be imitated by a produced decoy resource 22, which may be monitored by detection and termination module 14. Once an attacker tries to interact with such decoy resource 22, detection and termination module 14 may detect the interaction and terminate the attack in real time.

Digital minefield layer 10 may deploy process mines according to a policy or smart algorithm that may choose what process mines 20 should be created. In some embodiments of the present invention, digital minefield layer 10 may use an algorithm to identify a browser that is usually used by endpoint machine 15, for example a default browser of endpoint machine 15. Digital minefield layer 10 may use an algorithm to periodically produce a decoy instance of the browser. Such decoy instance of the browser may lure attacker 30 to interact with it, as described in detail herein. In some embodiments of the present invention, a policy to choose what process mines 20 should be created may be determined in accordance with the various software units and/or components installed in machine 15 and/or in computing environment 50. For example, in a POS endpoint, the policy may direct digital minefield layer 10 to create decoy resources of the specific software that is run on the POS.

Mines 20 may be added to a list of monitored decoy resource 22, which may be monitored by detection and termination module 14. For example, detection and termination module 14 may include a driver in the kernel level of OS 11, supplied with a function such as, for example, a callback function 16, and the function may be called every time a handle to a monitored resource such as, for example, process, file or object, is opened. According to some embodiments of the present invention, when attacker 30 looks for a resource to interact with, for example a file, process or object with certain characteristics, he will find a mine 20, e.g., a decoy resource 22 imitating the desired resource that has the same looked-for characteristics, and will interact with it by opening a handle 18 to decoy resource 22. Once a handle 18 is opened, OS 11 may execute callback function 16. Callback function 16 may check whether the resource accessed by the opened handle is one of the monitored resources. If the accessed resource is a monitored resource, callback function 16 may inform detection and termination module 14. Otherwise, access to the resource may be granted. Since decoy resource 22 is not supposed to be accessed in normal operation, there is a very high confidence that an attempt to access decoy resource 22 is performed by a hazardous attacker 30.

In some exemplary embodiments of the present invention, a mine 20 may include a network mine. A network mine may be used for deception of an attacker 30 trying to steal files from shares over Server Message Block (SMB) and or Common Internet File Systems (CIFS). Such attacker may scan the network for shares, for example in order to commit data exfiltration and/or lateral movement actions. A network mine may include monitored decoy network shares that may lure attacker 30 to interact with them. Once attacker 30 interacts with a monitored decoy network share, the interaction may be detected and stopped by detection and termination module 14.

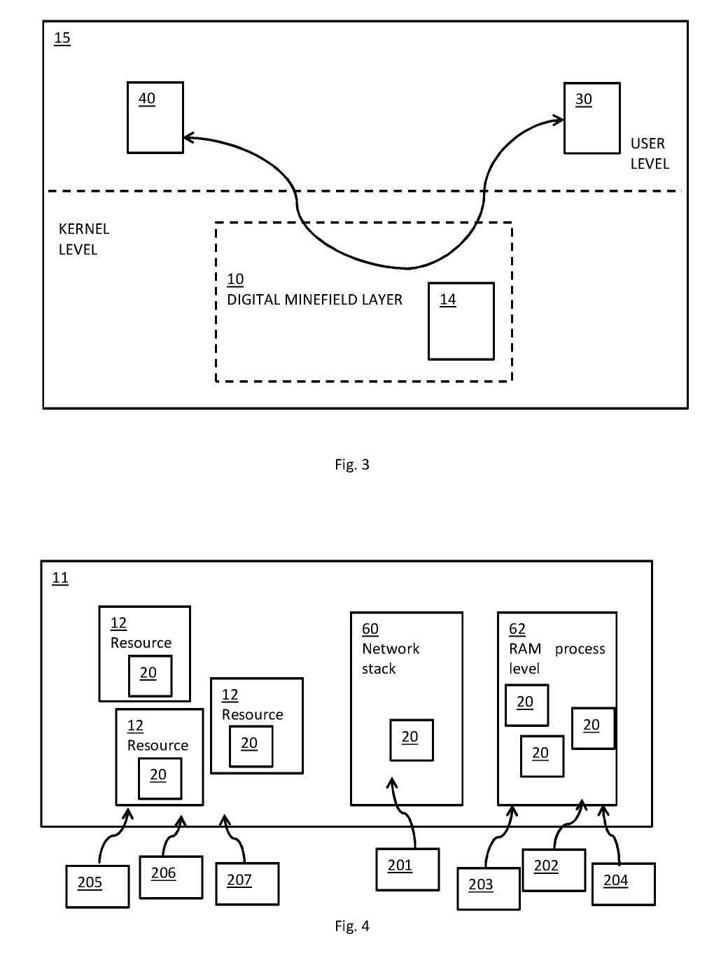

Reference is now made to FIG. 3, which is a schematic illustration of the operation of a network mine 21 according to some exemplary embodiments of the present invention. A network mine may include a separate decoy SMB stack 40 on endpoint machine 15. Attacker 30 may, for example, probe the kernel of machine 15 for interactions with network shares via machine 15. In case machine 15 has a local SMB stack for communication with shares across the network, attacker 30 may use the local SMB stack for requesting interaction with shares over the network. Decoy SMB stack 40 on the user level of machine 15 may respond to requests coming from attacker 30 via the kernel, for example from the local SMB stack. Attacker 30 may identify such responses as shares and therefore may try to connect with decoy SMB stack 40. Once attacker 30 interacts with a decoy SMB stack 40, the interaction may be detected and stopped by detection and termination module 14.

Reference is now made to FIG. 4, which is a schematic illustration of exemplary seven potential phases 201-207 of a cyber-attack chain, which may be blocked by minefield layer 10 that may be implemented in corresponding processes and layers of the OS, according to some embodiments of the present invention. Cyber-attack phases 201-207 may correspond to potential steps of a cyber-attack. In a reconnaissance phase 201, attacker 30 may perform reconnaissance of its target, for example environment 50 and/or at least one of machines 15. For example, attacker 30 may perform search, find organization charts, IP addresses, employee names, key names, and/or any other information that may be useful for preparation of the attack.

According to some embodiments of the present invention, minefield layer 10 may be integrated in layers and processes where potential targets may be located. For example, mines 20 such as, for example, registry hive decoy resources and/or network decoy resources, may be used to deceive attacker 30 and thus, for example, to block such reconnaissance. In some embodiments of the present invention, mines 20 may be integrated in the network stack 60 of OS 11 to deceive attacker 30.

In a weaponzation phase 202, attacker 30 may, for example, perform phishing, e.g., try to gain access to machine 15 by social engineering, for example by sending an e-mail with a link containing a malware, thus inserting the attack “weapon” to machine 15. In a delivery phase 203, attacker 30 may infiltrate and/or deliver a malware to machine 15, for example when the user opens an attachment or a link, and may perform installation of a malware. In an exploitation phase 204, attacker 30 may access machine 15, for example by activating the installed malware. According to some embodiments of the present invention, minefield layer 10 may be integrated in layers of OS 11 and processes where phases of weaponization, delivery and/or exploitation may be activated. For example, mines 20 such as memory decoy resources, process decoy resources and/or filesystem decoy resources, may be used, for example, to deceive attacker 30 and thus, for example, to prevent exploitation of the user's vulnerability and/or zero-day attacks. In some embodiments of the present invention, mines 20 may be integrated in the Random Access Memory (RAM) process level 62 to deceive attacker 30.

In an installation phase 205, attacker 30 may, for example, install additional malware and/or tools to facilitate further breach of the organization. For example, attacker 30 may activate Trojan or backdoor infections and/or access systems, files and/or processes in machine 15, for example by using permission obtained by the installed malware. In a command and control phase 206, attacker 30 may perform, for example, internal reconnaissance, lateral movement, and/or establish a command and control server to maintain access to resources in the target. In actions on target phase 207, attacker 30 may acquire data from the accessed systems, files and/or processes, and/or exfiltrate the acquired data outside from machine 15. According to some embodiments of the present invention, minefield layer 10 may be integrated in layers layers of OS 11 and processes where phases of installation, command and control, and actions of target may be activated. For example, mines 20 such as, for example, decoy resources that imitate memory, process, storage tables, passwords, drivers, network and/or filesystem resources, may be used, for example, to deceive attacker 30 and thus, for example, to prevent lateral movement and exfiltration of data. For example, mines 20 may be integrated in various resources 12 such as, for example, systems, files and/or processes to deceive attacker 30.

By having minefield layer 10 deployed in the various processes and layers of the OS that correspond to potential phases 201-207 of a cyber-attack chain, systems, files and/or processes of environment 50 may be protected also when shared in a cloud, when connected to a vulnerable wireless or wired network, and/or when exported outside from environment 50. By implementing mines 20 according to some embodiments of the present invention, systems, files and/or processes of environment 50 may be protected also when exported outside from environment 50 to a disconnected machine that has no internet connection with environment 50.

In some embodiments of the present invention, system 100 may include different mines 20 deployed on various layers and processes of environment 50 and on multiple machines 15, thus, for example, assuring that attacker 30 won't be able to learn and bypass minefield layer 10.

Reference is now made to FIG. 5, which is a schematic flowchart illustration of a method for cyber security according to some embodiments of the present invention. As indicated in block 410, the method may include deploying, by a digital minefield layer implemented in a computing environment, multiple decoy resources in various layers of an operating system of the computing environment, for example as described in detail above with reference to FIGS. 1-3. As indicated in block 420, the method may include monitoring the decoy resources by a detection module to detect interaction with at least one of the decoy resources, for example as described in detail above with reference to FIGS. 1-3.

As described in detail herein, detection module 14 may include a callback function in a kernel of an operating system 11 in computing environment 50, for example in each of multiple endpoint machines 15. As indicated in block 430, the method may include calling the callback function when a handle to a resource is being opened. As indicated in block 440, the method may include checking whether the resource accessed by the opened handle is one of the monitored resources. As indicated in block 450, the method may include that if the accessed resource is a monitored resource, the callback function informs the detection module, which may terminate the attack. As indicated in block 460, the method may include that if the accessed resource is not a monitored resource access to the resource is granted.

In some embodiments of the present invention, the deploying further includes deploying decoy resources in endpoint machines originating from the computing environment that are located outside the computing environment in a given moment, for example as described in detail herein above.

In some embodiments of the present invention, the decoy resources are configured to lure an attacker to interact with them, wherein such interaction indicates that an attack is occurring, and the method may further include detecting the interaction and stopping the attack in real time by the detection module, for example as described in detail herein above.

In some embodiments of the present invention, the decoy resources are imitations of potentially-targeted resources by an attacker, for example as described in detail herein above.

In some embodiments of the present invention, the method includes producing the decoy resources to imitate one of a list including: a point of sale (POS) software, a browser process, a process running by a domain admin, or another potentially targeted process, for example as described in detail herein above.

In some embodiments of the present invention, the deploying of the decoy resources is according to a policy or a smart algorithm.

In some embodiments of the present invention, the detection module may include a list of monitored decoy resources, and the method may further include adding a decoy resource to the list once the decoy resource is deployed.

In some embodiments of the present invention, the method may further include implementing the decoy resources in multiple layers of the operating system level and/or the RAM process level and/or in other resources, that may correspond to potential steps of a cyber-attack.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A system for cyber security, the system comprising:
a digital minefield layer implemented in a computing environment, comprising multiple decoy resources in various layers of said computing environment; and
a detection module to detect interaction with at least one of the decoy resources.

2. The system of claim 1, wherein said multiple decoy resources are deployed in various layers of an operating system of said computing environment.

3. The system of claim 1, wherein said digital minefield layer is further implemented in endpoint machines originating from the computing environment, that are located outside the computing environment in a given moment.

4. The system of claim 1, wherein the decoy resources are configured to lure an attacker to interact with them, wherein such interaction indicates that an attack is occurring, and wherein said detection module may detect the interaction and stop the attack in real time.

5. The system of claim 1, wherein the decoy resources are imitations of potentially-targeted resources by an attacker, said decoy resources are monitored by said detection module.

6. The system of claim 1, wherein at least one of the decoy resources is produced to imitate one of a list comprising: a point of sale (POS) software, a browser process, a process running by a domain admin, or another potentially targeted process.

7. The system of claim 1, wherein said digital minefield layer deploys the decoy resources according to a policy or a smart algorithm.

8. The system of claim 1, wherein said detection module comprises a list of monitored decoy resources, wherein once a decoy resource is deployed it is added to the list.

9. The system of claim 1, wherein said detection module comprises a callback function in a kernel of an operating system in said computing environment, the callback function is called when a handle to a resource is being opened, wherein said callback function checks whether the resource accessed by the opened handle is one of the monitored resources, and if the accessed resource is a monitored resource, the callback function informs the detection module, and otherwise access to the resource is granted.

10. The system of claim 1, wherein said decoy resources may be implemented in multiple layers of an operating system level and/or the RAM process level and/or in other resources corresponding to potential steps of a cyber-attack.

11. A method for cyber security, the method comprising:
deploying, by a digital minefield layer implemented in a computing environment, multiple decoy resources in various layers of said computing environment; and
monitoring the decoy resources by a detection module to detect interaction with at least one of the decoy resources.

12. The method of claim 11, wherein said multiple decoy resources are deployed in various layers of an operating system of said computing environment.

13. The method of claim 11, wherein said deploying further comprises deploying decoy resources in endpoint machines originating from the computing environment that are located outside the computing environment in a given moment.

14. The method of claim 11, wherein the decoy resources are configured to lure an attacker to interact with them, wherein such interaction indicates that an attack is occurring, and wherein said method further comprises detecting the interaction and stopping the attack in real time by the detection module.

15. The method of claim 11, wherein the decoy resources are imitations of potentially-targeted resources by an attacker.

16. The method of claim 11, further comprising producing by said digital minefield layer at least one of the decoy resources to imitate one of a list comprising: a point of sale (POS) software, a browser process, a process running by a domain admin, or another potentially targeted process.

17. The method of claim 11, further comprising deploying by said digital minefield layer the decoy resources according to a policy or a smart algorithm.

18. The method of claim 11, wherein said detection module comprises a list of monitored decoy resources, wherein said method further comprises adding a decoy resource to the list once the decoy resource is deployed.

19. The method of claim 11, wherein said detection module comprises a callback function in a kernel of an operating system in said computing environment, wherein the method further comprises calling said function when a handle to a resource is being opened, wherein said callback function checks whether the resource accessed by the opened handle is one of the monitored resources, and if the accessed resource is a monitored resource, the callback function informs the detection module, and otherwise access to the resource is granted.

20. The method of claim 11, further comprising implementing said decoy resources in multiple layers of an operating system level and/or the RAM process level and/or in other resources corresponding to potential steps of a cyber-attack.
